(19) United States
(12) Patent Application Publication
(10) Pub. No.: US 2020/0290227 A1
(43) Pub. Date: Sep. 17, 2020

(54) LR2

(71) Applicant: James Timothy Simmons, Sacramento, CA (US)

(72) Inventor: James Timothy Simmons, Sacramento, CA (US)

(21) Appl. No.: 16/501,219

(22) Filed: Mar. 11, 2019

(51) Int. Cl. B26B 21/56

(52) U.S. Cl. CPC B26B 21/56; B26B 21/22

(57) ABSTRACT

With the LR2 design, this safety razor now gives you a TWO blade stacked razor, as opposed to a single blade. With the LR2, you can shave from either the LEFT side or the RIGHT side of the razor and get a TWO-tiered stacked design. This will give the user the benefit of a multi-blade razor design, but now in a safety razor housing.

The LR2 razor blade design is a tier design. The razor blade is specifically designed for the current provisional single blade razor shaver. The LR2 design is a stacked fixed position with a dual razor blade design. The lower razor blade is slightly larger in length with the width set as the same size as the upper razor blade. The upper razor blade is adhered to supported by two cross section strips, securing both the upper and lower razor blades.

These supporting strips allows for narrower separation, from the top tier razor blade to rest in an interconnected comprised position with the lower razor blade.

With this design, the exposed erected facial hair that extends above the skin surface, is lifted and extended when the lower razor blade makes contact with the hair, allowing the second upper razor blade of cutting the unwanted facial hair at a much lower point of the hair shaft.

The LR2 razor blade design, is specifically designed for use in both the current provisional butterfly open face razor design also with the screw-down top shaver design.

### BACKGROUND OF THE INVENTION

The present invention relates to the provisional single blade razor blade design, having only a single blade removing the facial hair at the surface.

During the shaving process with a single blade, the facial hair is cut only at the surface skin area with a single blade.

With the use of the LR2 present invention design. The LR2 tiered blade designed, allows the first blade to make contact the hair which helps to lift the hair, allowing the second blade to cut the hair at a lower part of the hair. Providing a much closer and smoother shaved surface area.

### BRIEF SUMMARY OF THE INVENTION

The current LR2 invention provides a much smoother and cleaner shaved surface area then of the provisional single blade design.

Typically, the facial hair surface area is cut with a single blade design at the point of contact with the exposed hair.

With the present LR2 invention design, it is using a tiered stacked designed, the design makes contact with the facial hair, with the first blade contacting and lifting the hair, which allows the second blade cutting the hair at a much lower level, providing a cleaner closer shaved area.

### BRIEF DESCRIPTION OF THE DRAWINGS

FIG. 1 Depicts a partial side view illustration of the razor blades positioned in a tiered, stacked design. With the use of a support strip between the two razor blades attaching the upper razor blade to the lower razor blade.

FIG. 2 Is a partial perspective side profile view of the tiered razor blades, resting within a butterfly open shaver, set within the razor blade housing area.

FIG. 3 In this partial side view. Illustrating the LR2 tiered blade designed positioned within a screw-down top shaver. a closed-in shaving razor completely secured

FIG. 4 In this top view illustration the LR2 razor blade design illustrates the razor blades stack one on-top of the other, with the bottom blade edge slightly exposed.

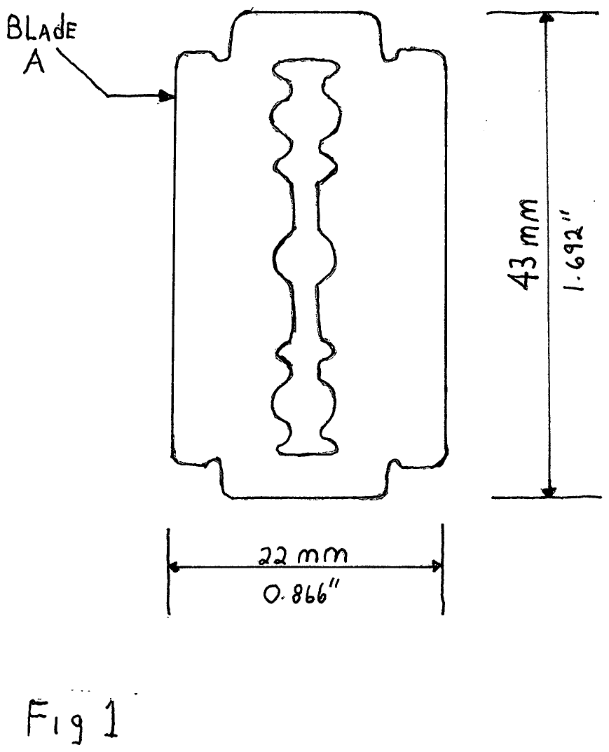

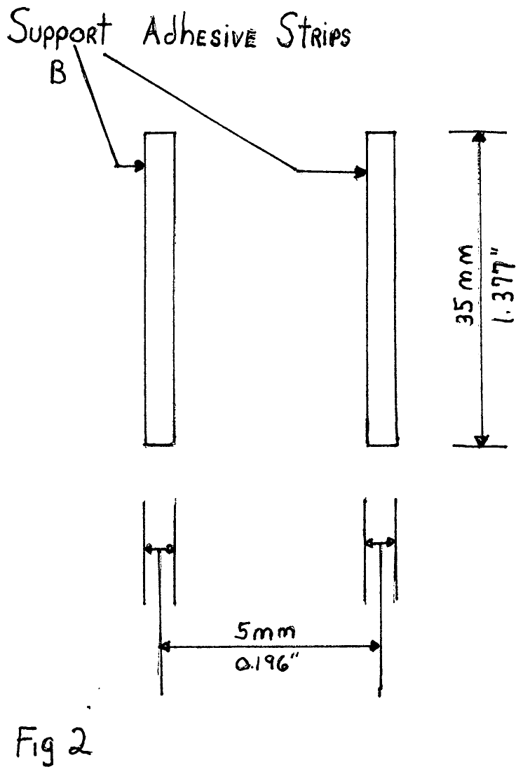

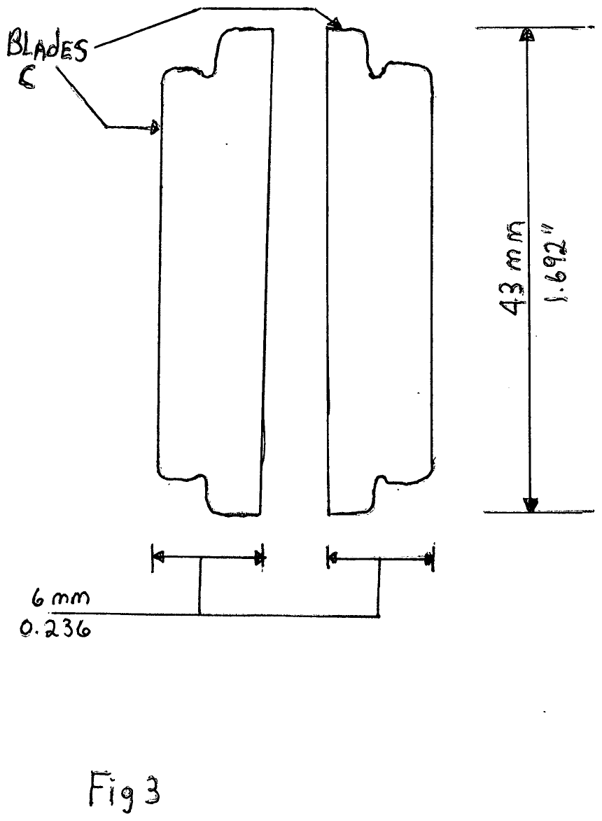

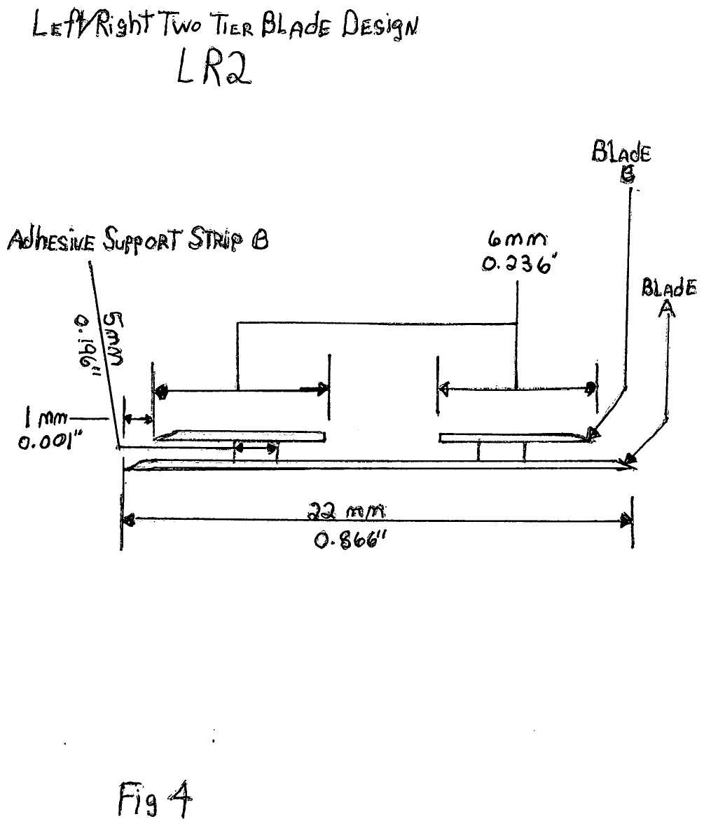

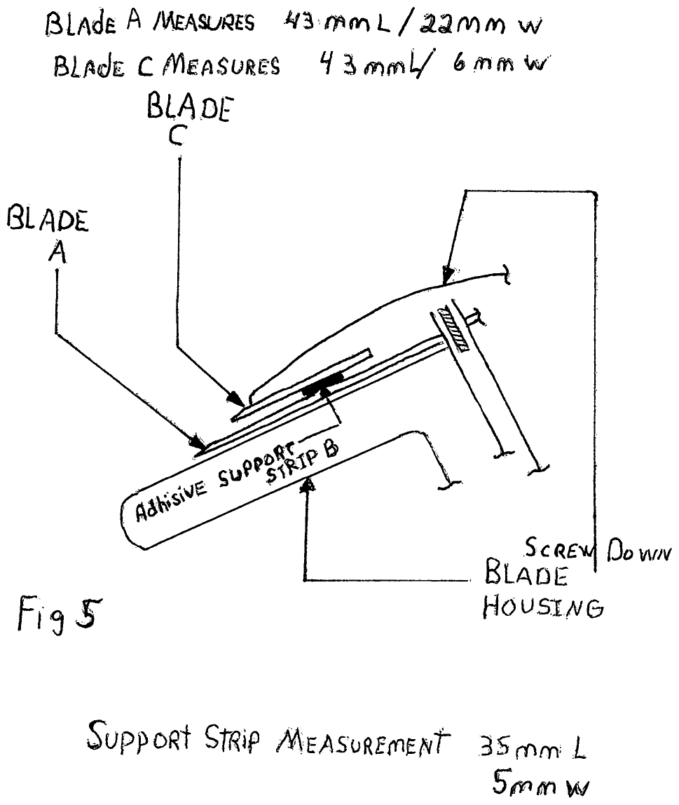

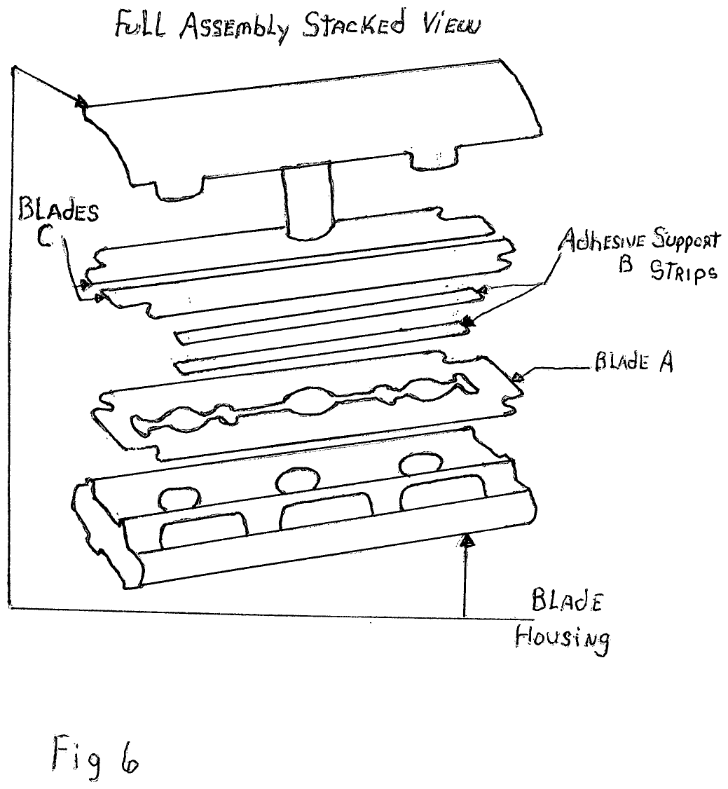

1: The LR2 denotes a left/right two tier razor blade design starting with a base razor blade [A] measuring 43 mm in length and 22 mm in width as shown in [FIG. 1] followed by two adhesive strips [C] each measuring 5 mm in width and 35 mm in length as shown in [FIG. 2] which are affixed to the base razor blade which support and affix the two top half razor blades [B] each measuring 6 mm in width and 43 mm in length as shown in [FIG. 3] which provides a much closer than a traditional single razor blade.

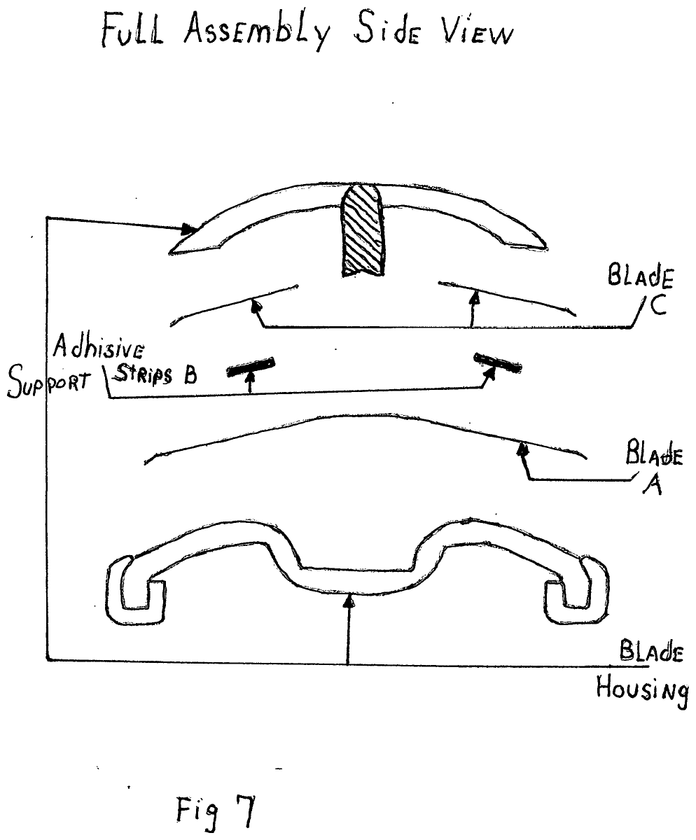

2: With the LR2 which denotes a left/right two tier razor blade design with the first razor blade [A] making first contact with the exposed facial hair by lifting which allows the second razor blade [C] to make a cut 1 mm in length as shown in [FIG. 4] lower down the exposed hair shaft before the hair follicle completely retracts under the facial skin surface giving the shaved skin area a much closer shave than a traditional single safety razor blade.

3: With the LR2 left/right two tier design it provides a much closer shave than a traditional single safety razor blade as shown in [FIG. 4] and in [FIG. 6] with this fixed stacked attached position this allows the LR2 left/right two tier design to rest securely with the screw down or butterfly razor blade housing.
